(19) United States
(12) Patent Application Publication
(10) Pub. No.: US 2019/0230929 A1
(43) Pub. Date: Aug. 1, 2019

(54) COMPOSITION FOR RESIDUAL SANITIZATION

(71) Applicant: W.M. Barr & Company, Inc., Memphis, TN (US)

(72) Inventor: Matthew Michael Petkus, Memphis, TN (US)

(21) Appl. No.: 16/260,566

(22) Filed: Jan. 29, 2019

Related U.S. Application Data
(60) Provisional application No. 62/623,666, filed on Jan. 30, 2018.

(51) Int. Cl. A01N 47/44; A01N 33/12; A01N 25/34; C08L 25/04; C11D 3/20

(52) U.S. Cl. CPC A01N 47/44; A01N 33/12; C11D 3/2003; C08L 25/04; A01N 25/34

(57) ABSTRACT

A composition for providing a residual sanitizing effect to a surface. The composition comprises a neutralized acrylic polymer, a neutralized acrylic resin or a combination thereof in combination, a biocidal active, and a carrier. The composition comprises a neutralized styrene acrylic polymer, a neutralized styrene acrylic resin or a combination thereof in combination, a biocidal active, and a carrier.

### CROSS-REFERENCE TO RELATED APPLICATIONS

This application claims priority from U.S. provisional patent application No. 62/623,666, filed on Jan. 30, 2018, in the United States Patent and Trademark Office. The disclosure of which is incorporated herein by reference in its entirety.

### FIELD OF THE INVENTION

The present invention relates to a composition for residual sanitization, particularly to a composition for residual sanitization comprising a neutralized acrylic.

### BACKGROUND OF THE INVENTION

Existing technology for residual sanitization or disinfectant cleaners often has problem with leaving streaks on certain surfaces and such streaks are not desirable to most consumers. Also, when put into a wipe application, the actual hand feel of the wipe is sticky leaving a non-pleasant feeling on the hands of a person after using the wipe product. Wipe applications are quite popular among consumers. Thus, there is a need for a substance that does not streak, is non-permeant, easily removable, and gives better hand feel when used in a wipe application yet has a residual disinfectant property.

### SUMMARY OF THE INVENTION

The present invention relates to a composition for residual sanitization comprising a film former and a biocidal active, wherein the film former is an acrylic polymer, an acrylic resin or a combination thereof, and the biocidal active is a quaternary amine (also referred to as a quaternary ammonium compound) or a mixture of quaternary amines.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### DESCRIPTION OF THE PREFERRED EMBODIMENTS

The present invention relates to a composition, also referred to herein as a formulation, for providing a residual sanitizing effect to a surface. The benefit of such a composition is that the residue left behind on the surface is transparent, shiny, and can be easily removed from the surface.

In an embodiment of the invention, the composition comprises a neutralized acrylic polymer, a neutralized acrylic resin or a combination thereof in combination with a biocidal active to provide a residual sanitizing effect. Preferably, the biocidal active is a quaternary amine or a mixture of quaternary amines. Preferably, the quaternary amine is present in an amount from about 0.05 weight % to 2 weight %. A non-limiting example of a commercially available quaternary amine having a biocidal property is Bardac 208M from Lonza.

In an embodiment of the invention, the composition comprises a styrene acrylic resin in combination with a biocidal active to provide a residual sanitizing effect. In an embodiment of the invention, the biocidal active is a quaternary amine or a mixture thereof. The styrene acrylic resin is typically supplied in its solid acidic form. The styrene acrylic resin is solubilized into the composition through its neutralization with a base.

In an embodiment of the invention, the biocidal active is polyhexamethylene biguanide (PHMB). Preferably, PHMB is present in an amount of 0.05 weight % to 2 weight %.

In an embodiment of the invention, the biocidal active is a silanated quaternary amine or a mixture of silanated quaternary amines. Preferably, the silanated quaternary amine is present in an amount of 0.05 weight % to 2 weight %.

In an embodiment of the invention, the composition preferably comprises a neutralized styrene acrylic resin.

For the neutralized styrene acrylic resin, the molecular weight (wt. av.) is preferably in a range of about 2,000 to 18,000, more preferably in a range of about 3,000 to 10,000. The glass transition temperature Tg (DSC) of the neutralized styrene acrylic resin is preferably in a range of about 100° C. to 120° C. The total amount solid neutralized styrene acrylic resin in the composition is in a range of about 0.5 weight % to 20 weight %.

Non-limiting examples of commercially available styrene acrylic resin are Joncryl (from BASF), Thyon (from Diransa), HSU-688 (from Jiangsu Chemical Co.).

A non-limiting example of a styrene acrylic polymer is Rhoplex, commercially available from The Dow Chemical Company.

The balance of the composition comprises a carrier such as water.

The composition may optionally comprise one or more of the following: a plasticizing agent, a nonionic surfactant, a fluoro surfactant, a coalescence solvent, a wax, a fragrance, and an additional polymer.

A non-limiting example of a plasticizing agent is tributoxyethyl phosphate. The plasticizing agent is preferably present in a range of 0 weight % to about 2 weight %, more preferably in a range of about 0.05 weight % to 1.5 weight %.

A non-ionic surfactant is preferably in a range of 0 weight % to 0.5 weight %. A non-limiting example of a commercially available non-ionic surfactant is Tomadol 91-2.5.

A non-limiting example of a coalescence solvent is diethylene glycol monoethyl ether. An example of such a commercially available coalescence solvent is Hostaphat TBEP from Clariant. The coalescence solvent is preferably in a range of 0 weight % to 2 weight %, more preferably 0.2 weight % to 1 weight %.

A non-limiting example of a wax is an oxidized polyethylene wax based emulsion. An example of such a commercially available wax is MegHWax AC 392 N35. The wax is preferably in a range of 0 weight % to 1 weight %.

Fragrance is preferably present in a range of 0 weight % to 1.5 weight %.

A carrier, preferably water, is the balance of the composition.

In an embodiment of the invention, a method for neutralization of the polymer or resin prior to addition into the composition is provided. The method comprises neutralizing the polymer or resin with ammonia. The method leaves a more permanent layer behind on the surface. To remove this layer from the surface, an alkaline washing solution either containing more ammonia or another base is used to scrub the surface to remove the residual layers.

In an embodiment of the invention, another method for neutralization of the polymer or resin prior to addition into the composition is provided. The method comprises neutralizing the polymer or resin with an amine such as monoethanol amine (MEA), triethanol amine (TEA), among others. Neutralization with an amine makes the layer left behind on the surface more water soluble. For example, if someone wants to remove the residual layer, a rag dampened in water can remove the residual layers. Since amines like MEA are stronger bases then the biocidal active quaternary amine, they dominate the acid/base equilibrium between the resin leaving the quaternary amine active to neutralize microorganisms.

For the resin neutralizer, amines comprising MEA or TEA or blends thereof are preferred. Ammonia can also as a neutralizer. Amount added is dependent on the acid value of the resin to reach neutralization. Optimal acid value of resin is 200 to 250.

The composition of the present invention is transparent, has a non-streaky residue, and is easily removable and delivers residual sanitization.

The following are non-limiting examples of compositions in accordance with the present invention.

Formula 1

| | Example A |
|---|---|
| Component | (weight %) |
| HSU-688 Resin (20% - Neutralized | 15.74 |
| with MEA) (Resin from Hsu (Jiangsu) | |
| Chemical Technology Co.) | |
| Tomadol 91-2.5 (Air Products and Chemicals) | 0.15 |
| Bardac 208M (Lonza) (80% active) | 1 |
| Glycol Ether DB (Acid Products) | 0.6 |
| Tris (2-butoxyethyl) phosphate (Tokyo | 0.2 |
| chemical industry) | |
| Water | 82.31 |
| Total Weight | 100 |

Formula 2

| | Example B |
|---|---|
| Component | (weight %) |
| HSU-688 Resin (20% - Neutralized | 15.7 |
| with MEA) Resin from Hsu (Jiangsu) | |
| Chemical Technology Co.) | |
| Tomadol (Air Products and Chemicals) | 0.1 |
| Bardac 208M (Lonza) (80% active) | 1 |
| Glycol Ether DB (Acid Products) | 0.5 |
| Tris (2-butoxyethyl) phosphate (Tokyo | 0.5 |
| chemical industry) | |
| Benzyl Alcohol (Kalama) | 0.25 |
| Water | 81.95 |
| Total Weight | 100 |

The neutralized styrene acrylic resin and the quaternary amine have a surprising synergistic effect when used in combination.

In an embodiment of the invention, an article comprising or having been treated with the composition of the present invention is provided.

The article may be a fabric or cloth. The article may comprise a synthetic or a natural material or a blend of synthetic and natural material. Examples of natural materials include, but are not limited to, cotton, linen, silk, wool, hemp and flax. Examples of synthetic materials include, but are not limited to, polypropylene, polystyrene, polyester, nylon, rayon, acrylic and spandex. The substrate may be woven or non-woven. The substrate may comprise a melt-blown polymeric material.

In an embodiment of the invention, the article is a wipe having up to 24-hour residual sanitization activity. The wipe is capable of protecting a hard surface from microbial growth and protection against bacteria without leaving a significant residue or build-up.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A composition for residual sanitization comprising:
a neutralized acrylic polymer, a neutralized acrylic resin, or a combination thereof,
a biocidal active, and
a carrier.

2. The composition according to claim 1, wherein the biocidal active is a quaternary amine or a mixture of quaternary amines.

3. The composition according to claim 1, wherein the biocidal active is polyhexamethylene biguanide (PHMB).

4. The composition according to claim 1, wherein the biocidal active is a silanated quaternary amine or a mixture of silanated quaternary amines.

5. The composition according to claim 1, wherein the biocidal active is present in an amount from about 0.05 weight % to 2 weight %.

6. The composition according to claim 1, wherein the carrier is water.

7. The composition according to claim 1, wherein the neutralized acrylic polymer is a neutralized styrene acrylic polymer.

8. The composition according to claim 1, wherein the neutralized acrylic resin is a neutralized styrene acrylic resin.

9. The composition according to claim 8, wherein the neutralized styrene acrylic resin has a molecular weight (wt. av.) in a range of about 2,000 to 18,000.

10. The composition according to claim 9, wherein the neutralized styrene acrylic resin has a molecular weight (wt. av.) in a range of about 3,000 to 10,000.

11. The composition according to claim 8, wherein the neutralized styrene acrylic resin has a glass transition temperature Tg (DSC) in a range of about 100° C. to 120° C.

12. The composition according to claim 8, wherein the neutralized styrene acrylic resin is in a form of a solid.

13. The composition according to claim 12, wherein the solid neutralized styrene acrylic resin in the composition is in a range of about 0.5 weight % to 20 weight %.

14. The composition according to claim 1, further comprising a component selected from the group consisting of a plasticizing agent, a nonionic surfactant, a fluoro surfactant, a coalescence solvent, a wax, a fragrance, a second polymer, and a combination thereof.

15. The composition according to claim 1, wherein the plasticizing agent is a tributoxyethyl phosphate.

16. The composition according to claim 1, wherein the plasticizing agent is present in a range of 0.05 weight % to about 2 weight %.

17. The composition according to claim 1, wherein the nonionic surfactant is present in a range of up to about 0.5 weight %.

18. The composition according to claim 1, wherein the coalescence solvent is diethylene glycol monoethyl ether.

19. The composition according to claim 1, wherein the coalescence solvent is present in a range of up to about 2 weight %.

20. The composition according to claim 1, wherein the wax is an oxidized polyethylene wax based emulsion.

21. The composition according to claim 1, wherein the wax is present in a range of up to 1 weight %.

22. The composition according to claim 1, further comprising benzyl alcohol.

23. The composition according to claim 1, wherein the benzyl alcohol is present in an amount of 0.25 weight % to 1.5 weight %.

24. A method of making a composition, the method comprising:
neutralizing a styrene acrylic polymer, a styrene acrylic resin, or a combination thereof with a base; and
adding the neutralized styrene acrylic polymer, neutralized styrene acrylic resin, or combination thereof to a composition comprising a carrier and a biocidal active.

25. The method according to claim 24, wherein the biocidal active is selected from the group consisting of quaternary amine or a mixture of quaternary amines, polyhexamethylene biguanide (PHMB), a silanated quaternary amine or a mixture of silanated quaternary amines, and a combination thereof.

26. The method according to claim 24, wherein the composition further comprises benzyl alcohol.

27. The method according to claim 24, wherein the base is selected from the group consisting of an ammonia, an amine, and a combination thereof.

28. The method according to claim 24, wherein the amine is selected from the group consisting of a monoethanol amine (MEA), triethanol amine (TEA), and a combination thereof.

29. An article treated with a composition for residual sanitization comprising:
a neutralized acrylic polymer, a neutralized acrylic resin, or a combination thereof,
a biocidal active, and
a carrier.

30. The article according to claim 29, wherein the article is in a form of a wipe.

31. The article according to claim 29, wherein the article comprises a synthetic material, a natural material, or a blend of synthetic and natural material.

32. The article according to claim 31, wherein the natural material is selected from the group consisting of cotton, linen, silk, wool, hemp, flax, and a combination thereof.

33. The article according to claim 31, wherein the synthetic material is selected from the group consisting of polypropylene, polystyrene, polyester, nylon, rayon, acrylic, spandex, and a combination thereof.

34. A method of using a composition, the method comprising:
treating a substrate with a composition comprising a neutralized acrylic polymer, a neutralized acrylic resin, or a combination thereof, a biocidal active, and a carrier.

35. The method according to claim 34, further comprising:
using the treated substrate to impart a residual sanitization activity to a surface.

36. The method according to claim 34, wherein the treated substrate has up to 24-hour residual sanitization activity.
